(19) United States
(12) Patent Application Publication
(10) Pub. No.: US 2005/0194715 A1
(43) Pub. Date: Sep. 8, 2005

(54) Method of manufacturing a hollow silicon rubber doll

(76) Inventor: Jung Huei Chen, Zhubei (TW)

Correspondence Address: MICHAEL L. DIAZ, P.C., 555 REPUBLIC DRIVE, SUITE 200, PIANO, TX, 75074, US

(21) Appl. No.: 11/070,956

(22) Filed: Mar. 3, 2005

(30) Foreign Application Priority Data
Mar. 5, 2004 (CN) 200410026403

(51) Int. Cl. B29C 45/00

(52) U.S. Cl. 264/255; 264/328.8

(57) ABSTRACT

The present invention relates to a method of manufacturing a hollow silicon rubber doll or doll semis. The method comprises the following steps: preparing the silicon rubber liquid; injecting the prepared silicon rubber liquid into the mold; removing any unwanted silicon rubber liquid while making an amount of silicon rubber liquid adhere to the interior wall of the mold; injecting some liquid with approximately the same density of the silicon rubber liquid into the mold with the silicon rubber liquid adhering to the interior wall.

### RELATED APPLICATIONS

### BACKGROUND OF THE INVENTION

1. Field of the Invention

The present invention relates to a method of manufacturing a doll, and particularly to a method of manufacturing a hollow silicon rubber doll or doll semis.

2. Description of the Related Art

In the prior art, a silicon rubber doll is generally solid. The method of manufacturing the silicon rubber dolls includes injecting prepared silicon rubber liquid into a mold. As the liquid completely hardens, the mold is opened to retrieve the silicon rubber doll. This method of manufacturing a silicon rubber doll has several drawbacks. First, raw materials of silicon rubber are consumed at a rate that greatly increases the cost of manufacturing the dolls. Secondly, since the mold has an opening smaller than the body of the doll, the mold must be disassembled. Alternatively, the opening of the mold must be cut bigger in order to take out the products. In either case, the steps are difficult and complicated, requiring several steps. In addition, a large amount of silicon rubber deckle edges are generated by the mold gap. Dealing with the edges is also tedious and time consuming. In addition, using existing manufacturing methods diminishes the aesthetics of the doll.

### SUMMARY OF THE INVENTION

Accordingly, an object of the present invention is to provide a method of manufacturing a hollow silicon rubber doll and/or doll semis to overcome the above-mentioned drawbacks of the prior art. The method is simple to operate, and produces hollow dolls or doll semis, thus saving a large number of silicon rubber raw materials. Further, as the mold of the present invention is integrative, the productions have no deckle edge and increases the aesthetics of the doll.

The method of manufacturing a hollow, silicon rubber doll or doll semis according to the present invention, comprises the following steps. First, the silicon rubber liquid is prepared. Next, the silicon rubber liquid is injected into a mold. Any unwanted silicon rubber liquid is removed. In addition, a specific amount of the silicon rubber liquid is adhered to an interior wall of the mold. Next, some liquid with approximately the same density of the silicon rubber liquid is injected into the mold with the silicon rubber liquid adhering to the interior wall while avoiding movement of the silicon rubber liquid adhering to the interior wall of the mold. Next, the silicon rubber liquid in the mold is hardened completed. The silicon rubber products are then removed, thereby providing the hollow silicon rubber doll or doll semis.

In order to get a better technological result, the method of manufacturing a hollow silicon rubber doll or doll semis further comprises the step of fixing the mold with the silicon rubber liquid adhering to the interior wall in a rotary plate and rotating it to prevent the silicon rubber liquid adhering to the interior wall from moving.

### BRIEF DESCRIPTION OF THE DRAWINGS

FIG. 1 is a flow chart outlining the steps of manufacturing a hollow silicon rubber doll or doll semis according to the teachings of the present invention;

FIG. 2 is a flow chart outlining the steps of manufacturing a hollow silicon rubber doll or doll semis in a second embodiment of the present invention; and

FIG. 3 is a flow chart outlining the steps of manufacturing a hollow silicon rubber doll or doll semis in a third embodiment of the present invention.

### DESCRIPTION OF THE INVENTION

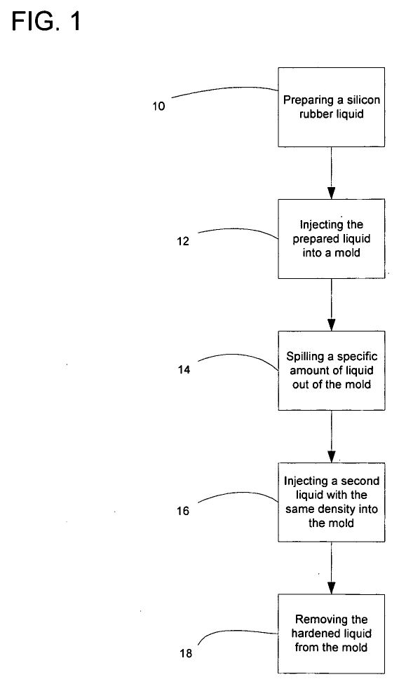

A method of manufacturing a hollow silicon rubber doll or doll semis is disclosed. FIG. 1 is a flow chart outlining the steps of manufacturing a hollow silicon rubber doll or doll semis according to the teachings of the present invention. With reference to FIG. 1, the steps of the method will now be explained. The method begins in step 10 by preparing a silicon rubber liquid. An amount of hardener is added and mixed evenly within the silicon rubber liquid. Next, in step 12, the prepared silicon rubber liquid is injected into an integrative and intact mold. In step 14, a specific amount of silicon rubber liquid is spilled out of the mold. Since some of the silicon rubber liquid has a strong viscosity, some residual silicon liquid adheres to the interior wall of the mold. In step 16, some liquid with approximately the same density of the silicon rubber liquid is injected into the mold without moving the silicon rubber liquid adhering to the interior wall of step 14. Next, in step 18, after the silicon rubber liquid in the mold has hardened completely, the silicon rubber products are removed, thereby providing the hollow silicon rubber doll or doll semis.

After taking out the silicon rubber dolls or doll semis in step 18, a small amount of powder may be smeared onto the surface of the silicon rubber products to reduce or prevent the surface from absorbing dust, hair, etc. The powder may be talcum powder or baby's toilet powder.

When preparing the liquid with approximately the same density of the silicon rubber liquid, dissoluble salt may be added to adjust the density, such as seawater, salt water, etc. or any other liquid with approximately the same density of the silicon rubber liquid may be used. However, all the liquid cannot dissolve into the silicon rubber liquid or hardener. Therefore, the same density of the silicon rubber liquid is required to avoid creating any uneven thickness of the products caused by the movement of the silicon rubber liquid prior to solidification.

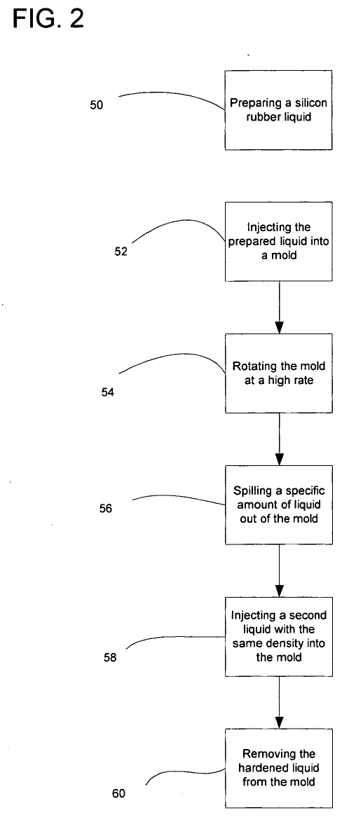

FIG. 2 is a flow chart outlining the steps of manufacturing a hollow silicon rubber doll or doll semis in a second embodiment of the present invention. With reference to FIG. 2, the steps of the method will now be explained. The method begins in step 50 where the silicon rubber liquid is prepared. An amount of hardener is added and mixed evenly within the silicon rubber liquid. In step 52, the prepared silicon rubber liquid is injected into a mold. Next, in step 54, the injected mold with the silicon rubber liquid is laid horizontally with its opening orientated upwards, and rotated at a high speed of approximately 800r/min or greater to make the bubbles in the liquid near the wall of the mold move from the center of the mold, thereby making the interior wall of the mold without any bubble detention. Thus, centrifugal force causes the silicon rubber liquid to contact with the interior wall of the mold. In step 56, a specific amount of silicon rubber liquid is spilled. Since some of the silicon rubber liquid has a strong viscosity, some residual silicon liquid adheres to the interior wall of the mold. In step 58, some liquid with approximately the same density of the silicon rubber liquid is injected into the mold without moving the silicon rubber liquid adhering to the interior wall of step 56. Next, in step 60, after the silicon rubber liquid in the mold has hardened completely, the silicon rubber products are removed, thereby providing the hollow silicon rubber doll or doll semis.

The bubbles in the silicon rubber liquid may also be removed before or after the mold with the vacuum deaeration commonly used in existing technology.

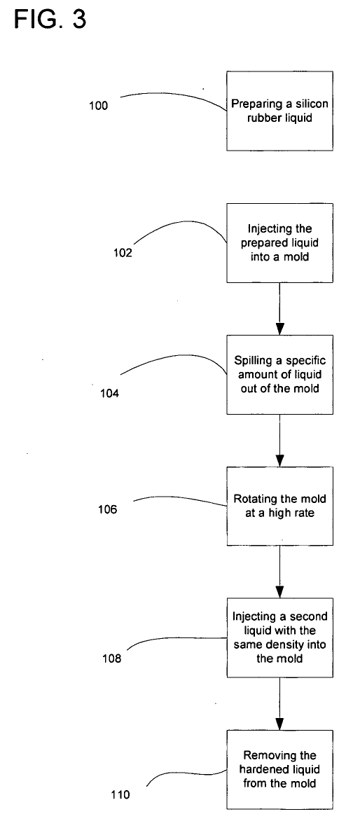

FIG. 3 is a flow chart outlining the steps of manufacturing a hollow silicon rubber doll or doll semis in a third embodiment of the present invention. With reference to FIG. 3, the steps of the method will now be explained. The method begins in step 100 by preparing silicon rubber liquid. An amount of hardener is added and mixed evenly within the silicon rubber liquid. Next, in step 102, the prepared silicon rubber liquid is injected into an integrative and intact mold. In step 104, a specific amount of silicon rubber liquid is spilled. Since some of the silicon rubber liquid has a strong viscosity, some residual silicon liquid adheres to the interior wall of the mold. Next, in step 106, the mold having the silicon rubber liquid adhering to the interior wall is fixed in a rotary plate and rotated to prevent the silicon rubber liquid adhering to the interior wall from moving. In step 108, some liquid with approximately the same density of the silicon rubber liquid is injected into the mold without moving the silicon rubber liquid adhering to the interior wall of step 104. Next, in step 110, after the silicon rubber liquid in the mold has hardened completely, the silicon rubber products are removed, thereby providing the hollow silicon rubber doll or doll semis.

The method of manufacturing a hollow silicon rubber doll according the present invention can be suitable for the manufacture of various kinds of formative dolls or doll semis, by utilizing their own specific molds.

The following table 1 is one set of exemplary formulas for preparing the silicon rubber liquid. This formula has been given for illustrative purposes only, and is not limiting.

TABLE 1

| Ingredient | Ratio (wt/wt) | Brand |
|---|---|---|
| Silicon rubber | 100 | Tempo Chemicals co., Ltd TW |
| RTV-1018 | | |
| Hardener #11 | 1.5 | Tempo Chemicals co., Ltd TW |
| Silicon oil | 20 | Tempo Chemicals co., Ltd TW |
| Colorant | 0.3 | Yun Sheng Toys Ltd. TW |

Comparing the prior art in the method of manufacturing a hollow silicon rubber doll and/or doll semis according to the present invention, after taking out the unwanted silicon rubber liquid and making the amount of silicon rubber liquid adhere to the interior wall of the mold, the movement of the silicon rubber liquid adhering to the interior wall of the mold interior is avoided because of the addition of the liquid with approximately the same density of the silicon rubber liquid. The production of these hollow silicon rubber doll or doll semi-manufactured solves the long-term problem confronting manufacturers attempting to manufacture hollow silicon rubber doll or doll semis by a simple operation. The present invention saves a substantial amount of silicon rubber raw materials. Furthermore, the mold can be integrative, thereby providing the production of the dolls and doll semis without any deckle edges to increase the aesthetics of the doll.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

1. A method of manufacturing a hollow silicon rubber doll or doll semis, the method comprising the steps of:
preparing a silicon rubber liquid;
injecting the silicon rubber liquid into a mold;
removing any unwanted silicon rubber liquid from the mold;
making a specific amount of the silicon rubber liquid adhere to the interior wall of the mold;
injecting a second liquid with approximately the same density of the silicon rubber liquid into the mold having the silicon rubber liquid adhering to the interior wall while avoiding movement of the adhering silicon rubber liquid;
after the silicon rubber liquid in the mold has hardened completely, removing the hardened silicon rubber liquid to provide the hollow silicon rubber doll or doll semis.

2. The method of manufacturing a hollow silicon rubber doll or a doll semis of claim 2, further comprising, before the step of removing any unwanted silicon rubber liquid, the step of removing bubbles in the silicon rubber liquid.

3. The method of manufacturing a hollow silicon rubber doll or a doll semis of claim 2, wherein the step of removing bubbles in the silicon rubber liquid further comprises the step of rotating the mold injected with the silicon rubber liquid at a high speed, thereby making the bubbles in the silicon rubber liquid near the wall of the mold separate from the center of the mold so as to make the interior wall of the mold without bubble detention and make the silicon rubber liquid firmly contact with the interior wall of the mold by centrifugal force.

4. The method of manufacturing a hollow silicon rubber doll or a doll semis of claim 2 wherein the step of rotating the mold to remove the bubbles in the silicon rubber liquid is by vacuum deaeration.

5. The method of manufacturing a hollow silicon rubber doll or a doll semis of claim 1, further comprising, after the step of removing any unwanted silicon rubber liquid, the steps of:
fixing the mold with the silicon rubber liquid adhering to the interior wall in a rotary plate; and
rotating the mold to prevent the silicon rubber liquid adhering to the interior wall from moving.

6. The method of manufacturing a hollow silicon rubber doll or a doll semis of claim 1, further comprising after the step of removing the hardened silicon rubber liquid, the step of smearing a tier of powder on the surface of the silicon rubber dolls or doll semis to reduce or prevent the surface of the doll or doll semis from absorbing dust, hair or dirt.

7. The method of manufacturing a hollow silicon rubber doll or a doll semis of claim 6, wherein the powder is talcum powder or baby toilet powder.
